(19) United States
(12) Patent Application Publication
(10) Pub. No.: US 2023/0239936 A1
(43) Pub. Date: Jul. 27, 2023

(54) REAL-TIME HIGH DATA RATE DEMODULATION METHOD USING MULTI-CORES OF GENERAL PURPOSE PROCESSOR IN PARALLEL

(71) Applicant: DAVID TODD MILLER, Ashburn, VA (US)

(72) Inventor: DAVID TODD MILLER, Ashburn, VA (US)

(21) Appl. No.: 17/581,814

(22) Filed: Jan. 21, 2022

(51) Int. Cl. H04W 74/08; H04B 1/00; H04W 28/08

(52) U.S. Cl. CPC H04W 74/0891; H04W 74/0875; H04B 1/0003; H04W 28/0983; H04L 27/2655

(57) ABSTRACT

A typical Software Defined Radio (SDR) receiver for Binary Phase Shift Keying (BPSK) or higher order modulations accepts an incoming digital serial complex I/O channel sample stream and performs demodulation functions to recover the original baseband data stream that another source transmitted. Typically, for real-time high data rate (HDR)>5.0 Megabits per second (Mbps) operations, a SDR unit requires an Application Specific Integrated Circuit (ASIC) component or Field Programmable Gate Array (FPGA) component to perform the customized Digital Signal Processing (DSP) intensive processing functions in real-time. However, ASIC chips and FPGAs are typically relatively expensive to develop, purchase, and/or reconfigure. With the parallel multi-core algorithm method of this claim, one can now implement a real-time HDR (>5.0 Mbps) SDR Demodulator with only Commercial-Off-The-Shelf (COTS) software, a relatively inexpensive personal computer (PC) or server that contains a single multi-core General Purpose Processor (GPP), and especially without using ASICS or FPGAs.

### REFERENCES CITED

U.S. PATENT DOCUMENTS

| | | |
|---|---|---|
| 8,565,811 B2 | 10/2013 | Tan, et al. |
| 9,252,920 B2 | 02/2016 | Drumm, et al |

### OTHER PUBLICATIONS

Grayver, Eugene, et. al, “Extreme Software Defined Radio—GHz in Real-time”, In Proceedings of the IEEE Aerospace Conference 2020, September, 2020.

Miller, David, “Demonstration of GNU Radio High Data Rate BPSK 10 Mbps Modem Real-Time with Only Multi-Core General Purpose Processors”, In Proceedings of the 11th GNU Radio Conference, September 2021.

### BACKGROUND

In the wireless communications industry, high data rate (HDR) Software Defined Radio (SDR) modulators and demodulators currently largely depend on Field Programmable Gate Array (FPGA) components and Application Specific Integrated Circuit (ASIC) components embedded in SDRs to achieve data rates >5.0 Mbps. The FPGA and ASIC components conduct the customized Digital Signal Processing (DSP) intensive processing synchronization functions in real-time.

However, FPGAs and ASICs are typically relatively expensive to develop, purchase, and/or reconfigure and one could reasonably conclude that SDRs with FPGAs and ASICs are not literally true SDRs because they depend on “firmware” or hardware components rather than “software” for their high speed DSP demodulation functions. Using firmware and hardware based components does not provide flexibility to quickly implement new waveforms and algorithms.

On the other hand, a General Purpose Processor (GPP) SDR using only software has a technical and financial advantage when one needs to modify or add new waveforms and algorithms quickly to the SDR. The GPP SDR approach also has much lower upfront costs for the baseline hardware, software, and development activity. Software SDRs are also easily portable from one GPP based PC/server unit/chassis to another.

The past disadvantage of SDRs using only General Purpose Processor (GPP) components in a Commercial-Off-The-Shelf (COTS) Personal Computers (PC) unit or server is that GPP SDRs have generally been limited to data rates of 5.0 Megabits per second (Mbps) in real-time because of the DSP processing speed limitations of GPP components with COTS operating systems and COTS software like C++.

However, a SDR implementer can now expand the real-time data rate capability of a GPP SDR by using a multi-core GPP PC or server at a relatively very low cost because of the following three recent trends in the Personal Computer (PC) and Server market and software industry:
A continuous improvement in the number of cores in a single GPP in a COTS PC or Server; and
a continuous lowering of costs for PCs/Servers with multi-core GPPs up to at least 64 cores; and
mature available COTS SDR Framework software for additional cost effectiveness.

Moore's Law on increasing the speeds on an individual GPP single core has mostly stagnated for at least the last 10 years. However, the PC/Server industry trend to expand the number of cores in a GPP now provides a path forward to greatly expand GPP SDR performance speeds to support much higher SDR real-time data rates.

Successful specific algorithm feasibility attempts at higher data rates with GPP SDRs and without FPGA or ASIC components have recently been achieved with the SDR prior art as discussed in the “Other Publications” references of this claim, but with one significant limitation. The limitation of the previous attempts is that those GPP HDR SDR approaches require a frame counter to recover the original transmitted frame stream after parallel chain processing. That frame counter approach may greatly reduce the commercial potential of the approach for customers of a satellite network for example who do not want to provide information to the network operator about their internal frame structure or even want a Network operator to “break” into their frames to process a counter. It is much more desirable to demodulate a HDR waveform in a more generic manner with parallel GPP core chains and recover the bits and frames in the original transmitted order without needing the detailed internal bit structure or counter inside the frames. Also, some frame structures like Consultative Committee for Space Data Systems (CCSDS) use virtual channels in their downlink frames with a separate frame counter for each virtual channel that makes the prior art approach awkward or possibly not even practical commercially.

Also, other parallel multi-core processing SDR attempts as discussed in the “U.S. Patent Documents” references of this claim for example provide general concepts of a SDR with parallel cores and/or complex approaches very different from the algorithm method of this claim to achieve high data rate operations with a GPP SDR. Therefore, those previous art approaches seem to lack a specific and straight-forward algorithm demodulation approach like adding preamble markers as complex I/O channel samples directly to fixed length chunks created from the incoming sample stream to efficiently take advantage of GPP multi-cores, COTS hardware, and COTS software in order to implement a cost-effective HDR GPP SDR demodulation unit.

Therefore, the wireless industry and especially the satellite ground station industry requires more cost effective and improved HDR SDR parallel multi-core algorithm methods that can be used with today's available COTS operating systems, COTS PC/servers, and existing COTS SDR Frameworks to implement a SDR demodulation unit.

The algorithm method of this claim provides a flexible and relatively cost effective method to achieve high date rates (>5.0 Mbps) with only a multi-core GPP SDR, a single COTS PC/server, COTS operating system, COTS and Modified-COTS SDR framework software for cost effectiveness and flexibility. The algorithm method of this claim also eliminates the limitations of the previous art implementations. For example, as discussed above, previous art limitations include the need to use frame counters, FPGAs/ASICs, or other proprietary and maybe overly complex customized methods to implement a HDR SDR Demodulator with today's available hardware and software.

### SUMMARY

The present algorithm method overcomes the problems and disadvantages of the prior art for high data rate (HDR) demodulation with a multi-core General Purpose Processor (GPP) Software Defined Radio (SDR) by adding a “preamble” as I/O channel complex samples directly to chunks of received complex I/O channel samples created from an incoming single continuous digital serial complex I/O channel sample stream before conducting parallel synchronization intensive processing.

When the Radio Frequency (RF) transmitting source uses Binary Phase Shift Keying (BPSK), Quadrature Phase Shift Keying (QPSK), or higher order modulation waveforms, a continuous bit stream >5.0 Megabits per second (Mbps), and equal length frames with a fixed bit pattern Acquisition Synchronization Marker (ASM), the algorithm method along with a multi-core GPP can be used to support real-time HDR SDR demodulation functions.

Specifically, the algorithm method conducts real-time HDR SDR demodulation functions by first breaking the incoming single serial complex I/O channel sample stream into parallel overlapping “chunk” streams and adds a complex I/O fixed pattern “Preamble” to each individual chunk in each chunk stream. Adding a preamble in complex I/O format to each chunk is only mildly similar to adding metadata tags as text and/or in “real type” format to samples and then the tags would propagate with the sample stream through the SDR demodulator processing blocks via a separate data flow or via extra processing at each SDR processing block. The tag approach would significantly impact the processing speed required by a HDR GPP SDR. Therefore, the approach of this preamble algorithm method does not use a metadata tag approach, but first directly inserts a preamble in complex I/O format into each chunk of each chunk stream for processing efficiency with a GPP SDR framework that streams samples/bits quickly into and out of each processing block. Then, secondly, the algorithm method sends the overlapping chunk streams with preambles to parallel symbol synchronization and carrier synchronization chains and each synchronization chain is assigned its own core. Then, thirdly and lastly, after conducting processing intensive synchronization functions using parallel synchronization chains and cores, the added chunk preamble along with the known frame ASM and known frame length are used to recover the original frame data stream that the original RF transmitting source generated, modulated, and radiated.

Along with the algorithm method of this claim, a SDR implementer only needs to use a Commercial-Off-The-Shelf (COTS) Personal Computer (PC) or server with a multi-core GPP, a COTS operating system, and COTS and Modified COTS software to implement a SDR Demodulator that can perform at real-time data rates >5.0 Mbps.

### BRIEF DESCRIPTION OF THE DRAWINGS

For a more complete understanding of the algorithm method in this claim, and the advantages thereof compared to the prior art, reference is now made to the following descriptions taken in conjunction with the accompanying drawings, in which:

FIG. 1 depicts the high level block diagram of a typical end-to-end wireless communications link that includes a Software Defined Radio (SDR) Demodulator;

FIG. 2 depicts a block diagram of a multi-core General Purpose Processor (GPP) SDR demodulator that depicts the functional blocks that conduct the preamble algorithm method in this claim, depicts data flows, and depicts standard demodulation blocks like symbol synchronizers and carrier synchronizers suitable for describing a typical application of the algorithm method principles;

FIG. 3 depicts a detailed block diagram of the functional blocks that conduct the front-end part of the algorithm method that breaks the incoming single serial complex I/O channel sample stream into multiple overlapping “chunk” sample streams;

FIG. 4 depicts a detailed block diagram of the functional blocks that conduct the front-end part of the algorithm method that adds a fixed pattern “Preamble” in complex I/O channel format to the beginning of each chunk before sending the multiple overlapping “chunk” streams to different parallel symbol synchronizer and carrier synchronizer chains;

FIG. 5 depicts a detailed block diagram of the blocks that conduct the back-end portion of the algorithm method that multiplexes the “chunk” bit stream outputs from the synchronization chains into a single bit stream by using the “Preamble Marker” of the full preamble that was added in the front-end of the GPP SDR Demodulator;

FIG. 6 depicts a detailed block diagram of the back-end blocks that extract the original transmitted stream of frames from the now single bit stream from the FIG. 5 output by using only the known frame Acquisition Synchronization Marker (ASM) and known frame length;

FIG. 7 depicts the Graphical User Interface (GUI) of one actual representative high data rate GPP SDR unit prototype that is already implemented with the algorithm method and can be used now as a demonstration, test, or operational SDR Demodulator unit and can be offered and demonstrated now to potential customers like a ground station network operator or a government agency;

FIG. 8 depicts a table that maps the prototype SDR Demodulator Front-End blocks in FIG. 7 to the equivalent functional blocks in FIG. 2;

FIG. 9 depicts a table that maps the prototype SDR Demodulator Parallel Synchronization Chains blocks in FIG. 7 to the equivalent functional blocks in FIG. 2;

FIG. 10 depicts a table that maps the prototype SDR Demodulator Back-End blocks in FIG. 7 to the equivalent functional blocks in FIG. 2.

### DETAILED DESCRIPTION

A multi-core General Purpose Processor (GPP) Software Defined Radio (SDR) unit that includes the algorithm method in this claim can demodulate waveforms at high data rates >5.0 Megabits per second (Mbps) in real-time and consists of three main parts.

The first part of the SDR Demodulator is called the “SDR Demodulator Front-End” that creates parallel chunk chain streams by generating multiple overlapping complex I/O channel sample streams from the incoming single continuous digital serial complex I/O channel sample stream. Creating each final chunk includes adding a known fixed pattern and fixed length “Preamble” in complex I/O format within each chunk in each chunk chain stream. The preamble approach is the key part of the algorithm method of this claim.

The second part of the SDR Demodulator is called the “SDR Demodulator Parallel Synchronization Chains” that process each chunk chain stream through its own separate Symbol Synchronization and Carrier Synchronization chain. At least one separate GPP core is allocated to each synchronization chain.

The third part of the SDR Demodulator is called the “SDR Demodulator Back-End” that conducts the frame recovery process by using the added chunk preamble marker of the preamble along with the known frame Acquisition Synchronization Marker (ASM) and known frame length to recover the original transmit source frame data stream in the correct order with no lost frames, no missing bits in frames, no duplicate frames from overlapping chunks, and no extra bits between frames because of the overlapping chunk parallel approach.

The multi-core GPP SDR Demodulator along with the algorithm method in this claim can perform demodulation processes under the following three communications link scope items at data rates >5.0 Mbps in real-time:
The transmitter source radiates a Radio Frequency (RF) signal with a continuous modulated stream of fixed length frames and each frame has an identical ASM pattern; and
the transmitter source uses Binary Phase Shift Keying (BPSK) modulation, Quadrature Phase Shift Keying (QPSK) modulation, or other higher order modulation that can support a continuous frame stream or bit stream modulation process; and
at the receive end of the communications link, a digital RF-To-Intermediate Frequency (IF) downconverter translates the incoming analog RF signal to a digital IF serial complex I/O channel sample stream (nominal 0.0 Hz complex I/O IF) and then the GPP SDR Demodulator ingests the incoming serial complex I/O channel sample stream from the digital RF-To-IF downconverter before the algorithm method and demodulation processes begin.

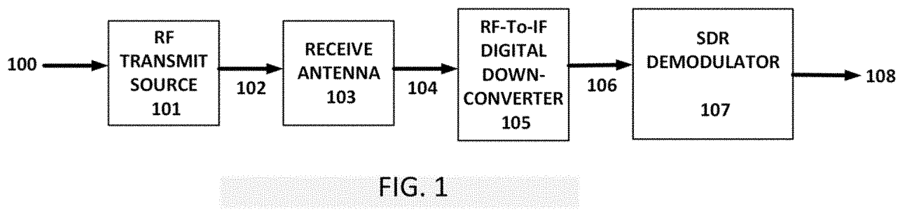

FIG. 1 depicts the high level block diagram of a GPP SDR Demodulator in a typical end-to end communications link. The Transmit Source 101 radiates the RF signal 102 to the Receive Antenna 103. The Transmit Source 101 generates the RF signal with a continuous frame stream 100 at >5.0 Mbps and BPSK, QPSK, or higher order modulation waveform. The RF-To-IF Digital Downconverter 105 translates the received RF signal to a digital IF with a nominal 0.0 Hz center frequency that is a digital serial complex I/O sample stream 106 that flows into the SDR Demodulator 107 input. The SDR Demodulator 107 includes a multi-core GPP Personal Computer/Server and the algorithm method of this claim that produces a demodulated output frame stream 108 at data rates >5.0 Mbps in real-time that is identical to the original frame stream and data rate that the Transmit Source 101 generated, modulated, and radiated. 104 depicts the analog signal flow in the receive system between 103 and 105.

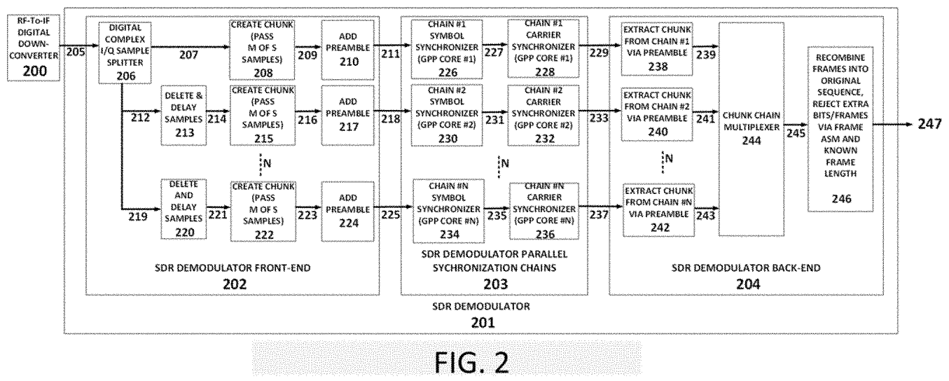

FIG. 2 zooms into the multi-core GPP Personal Computer/Server SDR Demodulator 201 and depicts the functional blocks and data flows of the GPP SDR Demodulator. The SDR Demodulator 201 includes the blocks that produce the algorithm method in this claim along with the standard SDR demodulation blocks like a Symbol Synchronizer and a Carrier Synchronizer suitable for describing a typical high data rate (HDR) demodulation application using the algorithm method and parallel multi-core principles. The Symbol Synchronizer and Carrier Synchronizer Blocks are the functions that require simultaneous parallel chains (1 to N) using at least one core for each chain because the synchronization functions are processing intensive at high data rates (>5.0 Mbps). The SDR Demodulator 201 implements the algorithm method of this claim after receiving the digital serial complex I/O channel sample stream from 200.

The SDR Demodulator Front-End 202 creates multiple overlapping complex I/O sample chunk chain streams from the incoming single serial complex I/O channel sample stream 205 via the Digital Complex I/O Sample Splitter 206 and Delay and Delete Functions for each chunk chain 213, 220, except the first chain. The SDR Demodulator Front-End creates each chunk with “M” samples from a block of “S” samples from the incoming serial complex I/O sample stream 205 with an overlap process 208, 215, and 222. Then, the SDR Demodulator Front-End adds a fixed pattern Preamble in complex I/O format to the front of each chunk in each chunk chain 210, 217, and 224. I/O sample data flows between blocks in 202 are depicted by 207, 209, 212, 214, 216, 219, 221, and 223. The resulting multiple parallel chunk chain streams 211, 218, and 225 then flow onto the second part of the SDR Demodulator. Adding a preamble in complex I/O format to each chunk is only mildly similar to adding metadata tags as text and/or in “real type” format to samples and then the tags would propagate with the sample stream through the SDR demodulator processing blocks via a separate data flow or via extra processing at each SDR processing block. The tag approach would significantly impact the processing speed required by a HDR GPP SDR. Therefore, the approach of this preamble algorithm method does not use a metadata tag approach, but directly inserts a preamble in complex I/O format into each chunk of each chunk stream for processing efficiency with a GPP SDR framework that streams samples/bits quickly into and out of each processing block.

The SDR Demodulator Parallel Synchronization Chains 203 conduct the processing intensive symbol synchronization and carrier synchronization functions. The inputs to 203 have a complex I/O type format, but the outputs from 203 are demodulated bits with a real type format. Each synchronization chain has a symbol synchronizer 226, 230, and 234 and a carrier synchronizer 228, 232, and 236. I/O sample data flows between the symbol synchronizer blocks and the carrier synchronizer blocks are depicted by 227, 231, and 235. Typically, for HDR SDR applications, a nominal two samples per symbol (or specifically two samples per bit if BPSK) are used and sufficient to achieve both good processing efficiency and good demodulation performance quality, but four samples per symbol could be used. The transmitting source symbol clock frequency and SDR Demodulator symbol clock frequency will not be identical, therefore the number of demodulated output symbols in a chunk will be about half the number of samples in the original chunk, but not always exactly half the number of samples. For example, the number of output bits per chunk with BPSK can vary by a few bits from exactly half. The non-deterministic number of bits per chunk of samples is actually the main reason the preamble is required to recombine or “stitch” the parallel chains' overlapping output streams back together into the exact original transmitter source single serial frame stream (bit stream) with no errors. The continuous re-synchronization at the beginning of each chunk that causes bad or degraded bits until synchronization lock is the reason that each chunk requires overlap relative to a previous chunk on the previous parallel chain.

The SDR Demodulator Back-End 204 recombines (“stitches”) the incoming chunk bit data flow streams 229, 233, and 237 from the Parallel Synchronization Chains 203 outputs back together into the original transmitting source frame/data stream order with no lost frames, no duplicate frames from overlapping chunks, no extra bits between frames, and no missing bits. The SDR Demodulator Back-End first extracts the chunks 238, 240, and 242 from each chunk chain and multiplexes the chunk chains 244 into a single serial stream of chunks 245 that flows onto the final functions 246 of the SDR Demodulator Back-End 204 and also the SDR Demodulator 201. The bit data flows between the chunk extraction blocks and the multiplexer are depicted by 239, 241, and 243. The final functions 246 use the frame ASM and known frame length to extract and recombine the frames into the original transmitted stream of frames. Specifically, the final functions 246 include using the known frame ASM and known frame length to remove the duplicate bits that still exist in the single multiplexed chunk stream 245 because of the earlier chain stream overlapping process. The output 247 of the SDR Demodulator now matches the input 100 to the original Transmit Source 101 of FIG. 1.

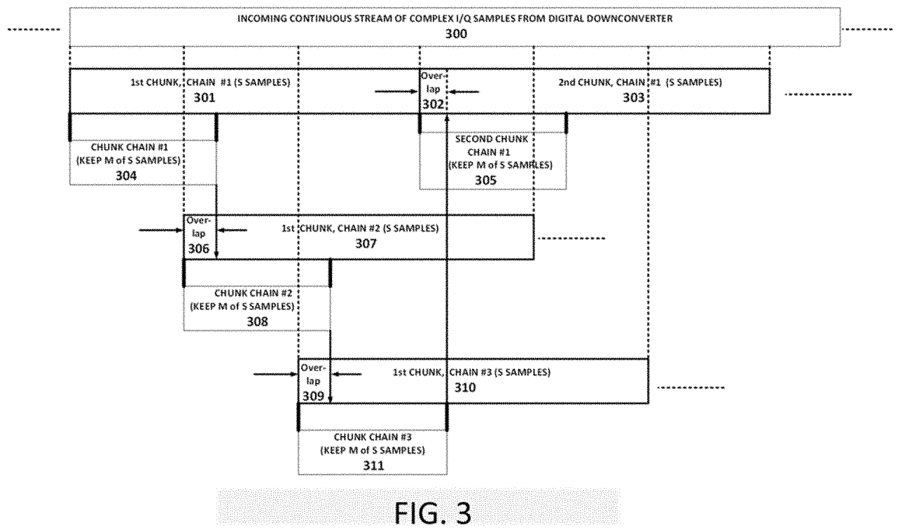

FIG. 3 provides a different view of the SDR Demodulator Front-End depicted in FIG. 2. FIG. 3 depicts the creation of chunks for three parallel chunk chains in the Front-End as an example, although the algorithm method can use many more parallel chunk chains depending on the required data rate and available GPP cores. FIG. 3 depicts how the incoming single serial complex I/O sample stream 300 is broken into separate overlapping sample “chunks” of the same length for each parallel chunk chain stream. The chunk creation process is started by initially taking a block of S samples 301, 303, 307, 310. The first M samples of S samples are kept and the remaining S samples discarded. 304, 308, 311, and 305 depict the created chunks of length M with an overlap 306, 309, and 302 relative to the previous chunk. FIG. 3 depicts all functions of the SDR Demodulator Front-End 202 except for the addition of the Preamble.

The chunk length can vary for each communications link depending on the frame length of the frame stream generated by the original transmitting source. Typically, a chunk length of about 10-20 frames provides simultaneously both efficient HDR processing performance and sufficiently low processing time latency between the SDR Demodulator input 205 and SDR Demodulator output 247.

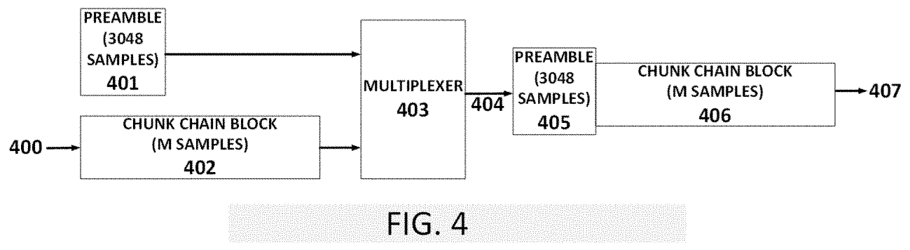

FIG. 4 depicts how a Preamble 401 is attached to the front of each and every chunk 402. 400 depicts the input flow from the blocks that create each chunk of M samples length. The multiplexer 403 adds the complex I/O preamble to each chunk 402. For example, the added fixed Chunk Preamble 401 for a BPSK implementation can start with a complex pattern of 1920 samples (corresponding to 1920/2 bits based on 2 samples/bit) as follows, but this claim allows other patterns of different lengths and also other patterns for higher order modulations to be used: “1+j0, 1+j0, −1+j0, −1+j0, 1+j0, 1+j0, −1+j0, −1+j0, 1+j0, 1+j0, −1+j0, −1+j0, −1+j0, 1+j0, −1+j0, −1+j0, 1+j0, 1+j0, −1+j0, −1+j0”. For higher order modulations, the complex part of a sample in the starting pattern will not be j0 in each sample, but will include both +j1 and −j1 values. The next part of the preamble is the 128 sample Chunk Preamble Marker (128/2 bits based on 2 samples/bit) also in I/O complex format and is a randomized pattern in bits for later chunk synchronization in the SDR Demodulator Back-End. Any 64 bit pattern (128 samples) with quality randomization characteristics for use as a synchronization marker can be used and this claim allows different marker lengths to be used also. Following the preamble marker is the final part of the preamble which is a 1000 zero sample sequence also in complex format (0+j0 for each sample) although this claim allows other different patterns after the preamble marker. Therefore, the total length of the preamble for the BPSK implementation example is 3048 complex I/O samples 401. Other higher order modulations would use different complex I/O sample preamble patterns and preamble lengths. The final created chunk with the complex I/O preamble exits at the multiplexer output 404. The preamble 405 is attached to the front of each M sample chunk 406 to complete the final construction of each chunk before it passes to the next block of the SDR as depicted by 407. The preamble samples before and after the preamble marker assist with later symbol synchronization and carrier synchronization that is required for each new chunk and preamble marker. Each SDR Demodulator Synchronization Chain must conduct two Re-synchronization processes for each passing M sample chunk and its preamble marker (synchronize on the preamble marker and then synchronize on the later chunk samples). However, the scope of this claim allows the preamble patterns, chunk lengths, and frames per chunk to be variable depending on the specifics of each waveform, frame stream received, and required processing time latency.

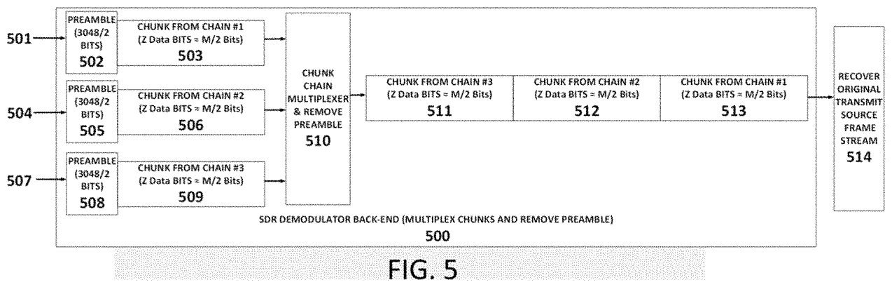

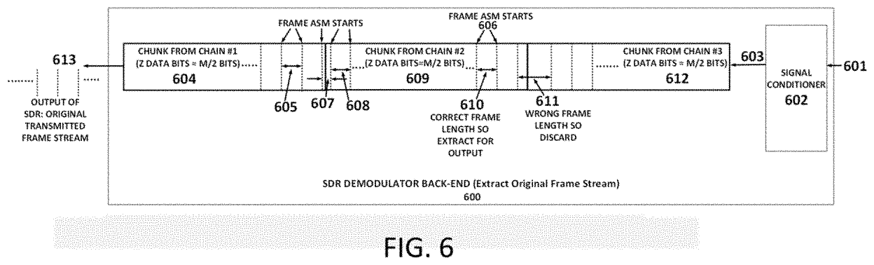

FIG. 5 depicts how the SDR Demodulator Back-End 500 uses 510 to multiplex the chunk streams (now bits not complex I/O samples) from each SDR Demodulator Synchronization Chain output 501, 504 and 507 into a final single stream of chunks 511, 512, 513 by using the Preamble Marker of each chunk. Each chain chunk has a preamble 502, 505, and 508 and about M/2 bits (BPSK as example) 503, 506, and 509 that follow each chunk preamble. Then, the final single stream of chunk bits flows 514 onto the final part of the SDR Demodulator Back-End where the original transmit source frame stream is extracted as FIG. 6 depicts.

FIG. 6 depicts the SDR Demodulator Back-End portion 600 that extracts the original serial frame/data stream generated by the original transmitting source. Specifically, the blocks in FIG. 6 ingest the incoming now serial sequential stream of chunks 601 and then extract the original transmitted frame stream by using only the known frame ASM and known frame length. 602 first conducts signal conditioning operations on the serial stream 601. The first signal conditioning operation is to remove the beginning overlap bits except for the last overlap bits of length about 1.03 times the frame length. 602 then conducts the second signal conditioning operation also that is to tag each frame ASM and flip bits as necessary to resolve phase ambiguity based on ASM bits (flip bits of frame and ASM as needed if all ASM bits (BPSK, QPSK) or some ASM bits (QPSK) are reversed because of carrier synchronization on wrong phase). Then, the 602 output stream 603 flows onto the final functions of the SDR Demodulator. As FIG. 6 depicts, a frame in a chunk is extracted from the now serial stream of chunks 604, 609, 612 as a correct valid frame only when the frame has a correct frame length 605 and 610 as measured between the start of the frame ASM and the start of the next frame ASM 606. When the distance between the start of the frame ASM and the next frame ASM is greater than the correct known frame length because of a chunk discontinuity/overlap, then the frame is discarded 611. A duplicate frame also occurs occasionally because of the chunk overlap. That duplicate frame 608 and the short frame that precedes it 607 are identified by the incorrect short frame between two ASMs 607. Then, both 607 and 608 are eliminated even though 608 has the correct frame length. Therefore, the output frame stream 613 now successfully and exactly matches the original frame stream 100 of the transmitting source 101 in FIG. 1 to complete the HDR demodulation process using the algorithm method of this claim with parallel GPP multi-cores.

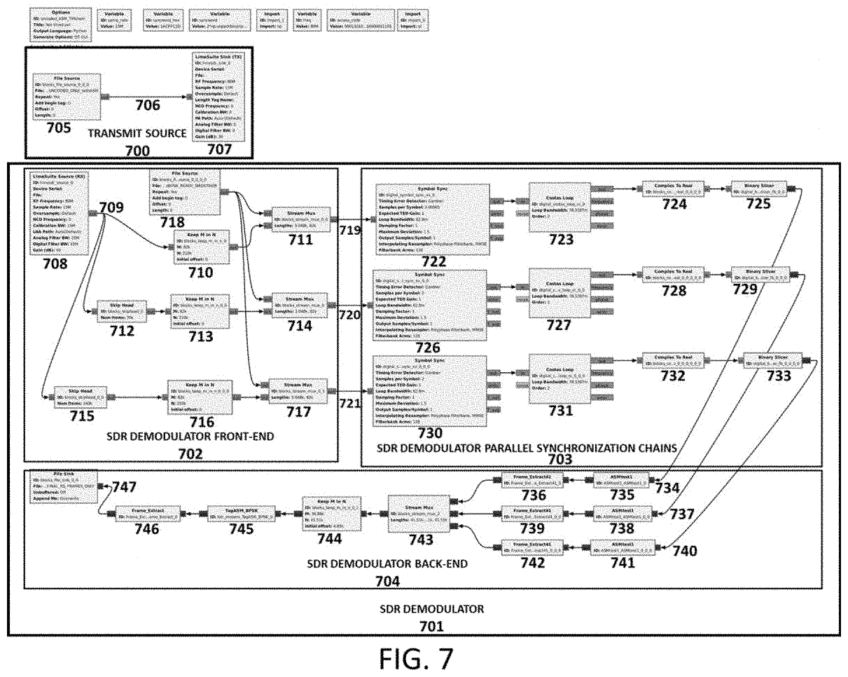

FIG. 7 depicts a GNU Radio Graphical User Interface (GUI) flow graph of one actual representative prototype HDR GPP SDR 701 that is available as an already implemented HDR SDR Demodulator with the algorithm method that can be used now for RF link demonstrations at 7.5 Mbps with BPSK. The prototype includes Commercial-Off-The-Shelf (COTS) and Modified-COTS open source GNU Radio Software, a GNU Radio GUI flow graph (FIG. 7), an 8-core GPP in a COTS Personal Computer (PC), COTS Linux Ubuntu operating system, incoming I/O sample stream of continuous frames provided by a LimeSDR-Mini (Manufactured by Lime Microsystems) RF-To-Digital IF complex I/O channel downconverter, and operation at two samples per bit.

FIG. 7 also includes a Transmit Source Subsystem 700, 705, and 707 for a RF loop test. The Transmit File Source 705 generates a continuous frame stream 706 of I/O samples at 2 samples/bit. The frame length is 1816 bits including a 32 bit frame ASM. The Consultative Committee for Space Systems (CCSDS) ASM 32 bit pattern (hexadecimal 1ACFFC1D) was used for the prototype SDR frames. 705 sends the continuous frame stream 706 to the LimeSDR-Mini Transmit module 707 (complex I/O Digital IF-To-RF Upconverter) for a BPSK 80.0 MHz RF loop back test configuration. The RF 80.0 MHz output of the LimeSDR-Mini is connected via coaxial cable directly to the RF input of the LimeSDR-Mini RF-to-IF Digital Downconverter 708 whose output is the continuous serial complex I/O channel sample stream 709.

FIG. 7 contains the three subsystems depicted also in FIG. 2 that implement the GPP SDR Demodulator with the algorithm method of this claim. The SDR Demodulator Front-End 702, the SDR Demodulator Parallel Synchronization Chains 703 (3 parallel chains for this prototype SDR), and the SDR Demodulator Back-End 704.

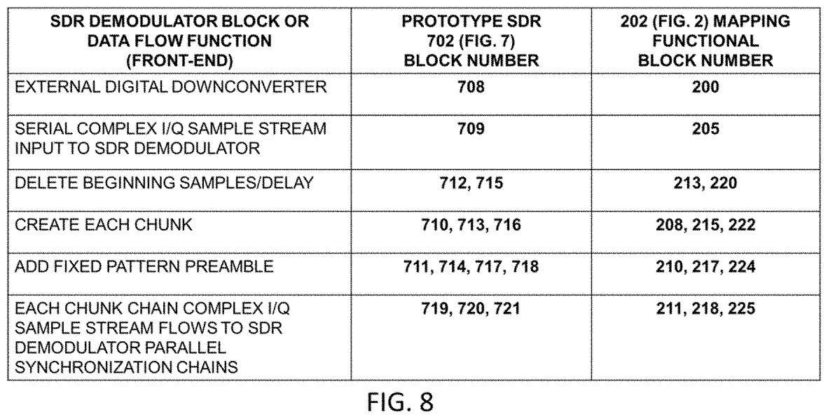

The blocks in 702 correspond to the functional blocks in the FIG. 2 SDR Demodulator Front-End 202. FIG. 8 depicts a table that maps each block and each data flow in 702 to the equivalent functional SDR Demodulator Front-End blocks in 202 of FIG. 2. For example, 710, 712, 713, 715, and 716 of the prototype SDR conduct the delete, delay, and chunk create functions defined by 208, 213, 215, 220, and 222. Also, 711, 714, 717, and 718 of the prototype SDR Demodulator conduct the “Add Preamble” functions of the algorithm method functions defined by 210, 217, and 224. The sample stream flows from 702 to 703 are shown by 719, 720, and 721.

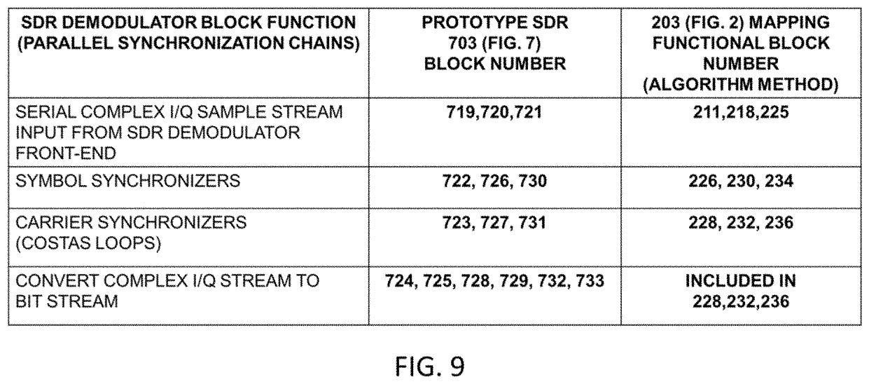

The blocks in 703 correspond to the functional blocks in the FIG. 2 SDR Demodulator Parallel Synchronization Chains 203. FIG. 9 depicts a table that maps each block and each data flow in 703 to the equivalent functional SDR Demodulator Parallel Synchronization Chains blocks 203 of FIG. 2. For example, 722, 723, 724, 725, 726, 727, 728, 729, 730, 731, 732, and 733 of the prototype SDR conduct the synchronization chain functions (including converting the 703 input complex I/O sample streams to demodulated real type bit streams) defined by 226, 228, 230, 232, 234, and 236.

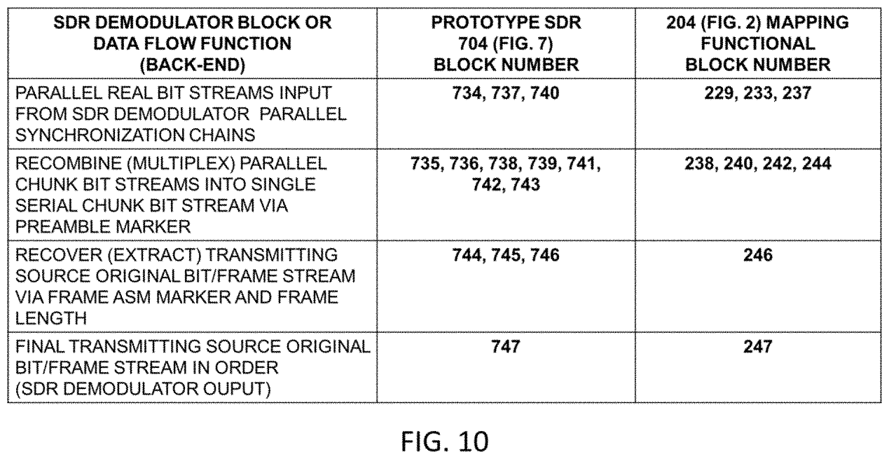

The blocks in 704 correspond to the functional blocks in the FIG. 2 SDR Demodulator Back-End 204. FIG. 10 depicts a table that maps each block and each data flow in 704 to the equivalent functional SDR Demodulator Back-End blocks 204 of FIG. 2. For example, 734, 735, 736, 737, 738, 739, 740, 741, 742, 743, 744, 745, and 746 of the prototype SDR conduct the Back-End functions defined by 238, 240, 242, 244, and 246. The final recovered original transmit source frame stream (SDR Demodulator output) is 747.

GNU Radio C++ In-Tree blocks (Blocks already available with GNU Radio with no changes required) and customized modified GNU Radio C++ blocks were used to implement the prototype SDR Demodulator with the algorithm method of this claim. However, the algorithm method claim extends to other SDR frameworks, not just GNU Radio or SDR frameworks based on C++ code. Also, different RF loop test scenarios were conducted with the prototype HDR GPP SDR of FIG. 7 in order to verify the viability, robustness, and performance of the algorithm method: Carrier Frequency Offsets, Symbol Rate Frequency Offsets, and the addition of noise.

1. Algorithm method to conduct real-time high data rate (HDR) demodulation of wireless waveforms with continuous frame streams comprising:
A Software Defined Radio (SDR) framework with the algorithm method of this claim to provide a means of using parallel symbol synchronization and carrier synchronization chains with a multi-core General Purpose Processor (GPP) to conduct the processing intensive SDR synchronization functions in real-time at data rates >5.0 Megabits per second (Mbps); and
before multi-core parallel processing, the algorithm method specifically includes adding a preamble as complex I/O channel samples directly into each individual chunk of complex I/O samples created from an incoming single continuous digital serial complex I/O sample stream; and
after multi-core processing, the algorithm method also includes using the added preamble, known frame Acquisition Synchronization Marker (ASM), and known frame length to recover the original continuous frame stream that the transmitter source originally generated, modulated, and radiated.
